(19) United States
(12) Patent Application Publication
(10) Pub. No.: US 2004/0219337 A1
(43) Pub. Date: Nov. 4, 2004

(54) Breathable blood and viral barrier fabric

(75) Inventors: John D. Langley, Guntersville, AL (US); Todd R. Carroll, Guntersville, AL (US); Barry S. Hinkle, Guntersville, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kappler, Inc.

(21) Appl. No.: 10/793,985

(22) Filed: Mar. 5, 2004

Related U.S. Application Data
(63) Continuation-in-part of application No. 10/303,572, filed on Nov. 25, 2002.
(60) Provisional application No. 60/452,413, filed on Mar. 6, 2003.

(51) Int. Cl. B32B 3/06

(52) U.S. Cl. 428/198

(57) ABSTRACT

The composite fabric of the invention provides a barrier to blood and viral challenges, and also provides breathability for comfort. The fabric is particularly suited for use as a disposable surgical gown. The fabric comprises a nonwoven fabric substrate with a first microporous resin layer on one surface and a second microporous resin layer on the opposite surface.

### CROSS-REFERENCE TO RELATED APPLICATIONS

This application is a continuation-in-part of U.S. patent application Ser. No. 10/303,572 filed Nov. 25, 2002 and also claims priority from U.S. Provisional Patent Application No. 60/452,413 filed Mar. 6, 2003.

### FIELD OF THE INVENTION

The present invention relates to a composite fabric, and more particularly, to a composite fabric having blood and viral barrier properties that make the fabric suitable for use as a protective garment in healthcare applications.

### BACKGROUND OF THE INVENTION

In the healthcare field, there is an awareness of the need to provide protection to healthcare workers against the spread of communicable viral or blood-borne diseases, such as AIDS and hepatitis. Protective fabrics for use in surgical gowns, masks, drapes and other protective apparel have been developed for this purpose. Regulations and standards such as the OHSA Universal Precautions act and the current proposed Surgical Gown classification standards under development by the Association for the Advancement of Medical Instrumentation (AAMI) further contribute to the awareness of this need.

Industry standards for assessing the barrier properties of protective fabrics against penetration by blood and viral agents include ASTM F1670, Standard Test Method for Resistance of Materials Used in Protective Clothing to Penetration by Synthetic Blood, and ASTM F1671, Standard Test Method for Resistance of Materials Used in Protective Clothing to Penetration by Blood-Borne Pathogens Using Phi-x 174 Bacteriophage Penetration as a Test System.

Protective fabrics are available that meet the above barrier standards (ASTM F1670 and ASTM F1671) at a reasonable cost, but these fabrics are not breathable. These are typically plastic coated fabrics. Their lack of breathability significantly contributes to the discomfort and heat stress of the wearer. One way that gown manufacturers try to improve comfort is by using the coated fabrics only in the frontal and arm areas of the gown. However, this practice compromises protection in other areas of the body.

A common method used by industry to determine the breathability of a barrier fabric is Moisture Vapor Transfer Rate (MVTR) as determined by ASTM E96, Standard Test Methods for Water Vapor Transmission of Materials. There are breathable barrier fabrics available that provide moisture vapor transfer while passing ASTM F1670 and ASTM F1671. These barrier fabrics are based on perfluoroethylene or copolyester films and membranes. However, because of their expense, they are typically used in protective garments that are reusable, and have limited applicability as disposable garments. Several attempts have been made to reduce the cost of a blood and viral barrier, such as the fabrics described in Langley U.S. Pat. Nos. 5,409,761; 5,560,974 and 5,728,451. Garments in accordance with these patents have been sold by Kappler Inc. under the trade name of Pro/Vent®. The product has performed well but must command a premium price as compared to conventional low cost non-barrier gowns manufactured from spunbond-meltblown-spunbond (SMS) composite fabrics or spunlaced pulp/polyester fabrics (e.g. DuPont's Sontara®) that dominate the disposable medical gown market.

One way of obtaining favorable economics in a breathable composite material utilizes a process wherein a polymer containing a mechanical pore forming agent is extruded in a single pass onto a nonwoven fabric and subsequently incrementally stretched in the cross machine and/or machine direction. The resulting composite material is microporous. It is impervious to the passage of liquids while the presence of micropores provides moisture vapor or air permeability. For example, micropores in the range of about 0.1 micron to about 1 micron can be formed in the composite. Such technologies are described in Wu et al. U.S. Pat. No. 5,865,926 and Brady et al. U.S. Pat. No. 6,258,308, the disclosures of which are incorporated herein by reference. A disadvantage of this type of coating process as compared to a lamination process such as that described in the above-noted U.S. Pat. No. 5,409,761 is that the extrusion coating process has a tendency to form pinholes or discontinuities in the fabric. Such pinholes can cause failure of both ASTM F1670 and ASTM F1671. If the pinholes are sufficiently small, e.g. microscopic, the coating may pass the ASTM F1670 blood penetration test, but would nonetheless fail the more stringent viral penetration test of ASTM F1671.

The industry accepted requirements for making a claim that a medical fabric passes ASTM F1671 is a pass rate of 29 out of 32 samples tested. This level is also recommended by the Federal Drug Administration (FDA) as the acceptable quality level (AQL) for making a claim to passing ASTM F1671. This quality level is based on an AQL of 4% per the sampling plans described in ANSI/ASQC Z1.4-1993, MIL 105E or ISO 2859-1, Table X-G-2. It can be seen that a frequency of 29/32 or 90.625% is the absolute minimum number of passes that must be generated to make the claim that the fabric passes ASTM F1671. Another way of stating the above is that the number of pinholes or imperfections cannot exceed 9.375% as an absolute maximum. In practice a much smaller frequency of pinhole or imperfection occurrence would be desirable.

An object of the present invention is to provide an economical fabric that will meet the stringent requirements of the ASTM F1671 viral penetration test while maintaining breathability and comfort.

### SUMMARY OF THE INVENTION

The present invention provides a fabric formed of at least one microporous ply. The present invention achieves a synergistic improvement in performance by combining multiple thin microporous resin layers on one or more plies of nonwoven fabric. The individual microporous resin layers may be so thin that they would otherwise fail the industry recognized standard for viral penetration resistance (ASTM F1671) if tested individually, but collectively the combination will pass the viral penetration resistance test (ASTM F1671).

According to one aspect, the present invention provides a composite fabric comprising a nonwoven fabric substrate having first and second opposite surfaces; with a first microporous resin layer on the first surface of the substrate and with a second microporous resin layer on the second substrate surface. The first and second microporous resin layers fail the ASTM F1671 viral barrier test when tested as individual layers, but the composite fabric passes the ASTM F1671 viral barrier test. At least one of the microporous resin layers may comprise a microporous formable resin that has been extrusion coated onto the surface of the nonwoven fabric substrate and subsequently rendered microporous by stretching. In one specific embodiment, both of the microporous resin layers comprise a microporous formable resin that has been extrusion coated onto the surface of said nonwoven fabric substrate and subsequently rendered microporous by stretching. In another specific embodiment, one or more of the microporous resin layers may comprises a microporous free film that has been laminated to the nonwoven fabric substrate.

According to a further aspect of the invention, a composite fabric is provided comprising a first microporous coating comprising a microporous formable resin that has been extrusion coated onto one surface of a nonwoven fabric substrate and an additional microporous coating that has been extrusion coated onto the opposite surface, with the coatings having been rendered microporous by stretching. Preferably, the composite fabric has a MVTR at least 300 g/m²/24 hr, and more desirably, the MVTR is at least 600 g/m²/24 hr.

In a further more specific embodiment, the composite fabric comprises a nonwoven fabric substrate formed of substantially continuous filaments, and extrusion coatings of a filler-containing microporous formable thermoplastic resin adhered to opposite surfaces of the nonwoven fabric substrate. A multiplicity of micropores formed in the extrusion coating impart microporosity to the ply and a MVTR of at least 300 g/m²/24 hr.

The composite fabric may include a second ply positioned adjacent to the above-described fabric ply in opposing surface-to-surface relationship. The second ply may comprise a nonwoven fabric, an unsupported microporous film, or another microporous layer comprising a nonwoven fabric substrate and a microporous formable resin that has been extrusion coated onto the nonwoven fabric substrate and subsequently stretched to impart microporosity. The composite fabric may include a discrete bond sites interconnecting the first and second plies. Alternatively, the first and second plies are separate from one another over substantially the entire extent of their opposing surfaces, but peripheral portions of the plies are connected to one another to maintain the plies in close proximity to each other. For example, peripheral portions of the plies can be joined by at least one area of thermal or ultrasonic bonds.

According to further aspects of the present invention, the microporous composite fabric may be fabricated into medical protective apparel, such as medical gowns, foot covers, head covers, face masks or sleeve protectors. The fabric may also be fabricated into a surgical drape.

The present invention also provides a method of making a composite fabric comprising the steps of providing a nonwoven fabric substrate having first and second opposite surfaces; applying a first a microporous resin layer to the first surface of said nonwoven fabric substrate; applying a second microporous resin layer to the second surface of said nonwoven fabric substrate; and wherein said first and second microporous layers fail the ASTM F1671 viral barrier test when tested as individual layers, but wherein the composite fabric passes the ASTM F1671 viral barrier test.

### BRIEF DESCRIPTION OF THE DRAWINGS

Some of the features and advantages of the invention having been described, others will become apparent from the detailed description which follows, and from the accompanying drawings, which are not necessarily drawn to scale, and wherein:

FIG. 1 is a perspective view showing a protective medical gown produced from a composite fabric in accordance with the present invention.

FIG. 2 is an exploded perspective view showing a composite fabric.

FIGS. 3, 4, 5 and 6 are enlarged cross-sectional views of several embodiments of composite fabrics.

FIG. 7 is a perspective view showing two microporous plies cutout to form the sleeve component for a disposable surgical gown and joined together along their periphery.

FIG. 8 is an enlarged cross-section view of a composite fabric in accordance with an embodiment of the present invention.

### DETAILED DESCRIPTION OF ILLUSTRATIVE EMBODIMENTS

The present invention now will be described more fully with reference to the accompanying drawings, in which some, but not all embodiments of the invention are shown. Indeed, the present invention may be embodied in many different forms and should not be construed as being limited to the specific illustrative embodiments set forth herein; rather, these embodiments are provided so that this disclosure will satisfy applicable legal requirements. Like numbers refer to like elements throughout.

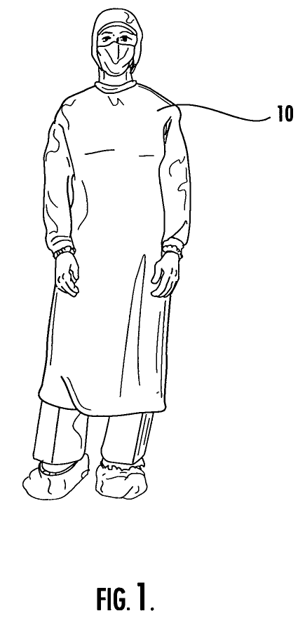

Referring to the drawings, there is shown in FIG. 1 a protective medical gown 10 in accordance with the present invention. The medical gown 10 is fabricated from a composite fabric that provides a barrier to blood and viral agents, and meets the requirements of ASTM F1670 and ASTM F1671. The composite fabric is breathable to provide comfort to the wearer. The composite fabric has a breathability, expressed in terms of MVTR as measured by ASTM E96 of at least 300 g/m²/24 hr at standard conditions of about 75° F. and a relative humidity of about 65%. Preferably, the fabric has a MVTR of at least 300 g/m²/24 hr.

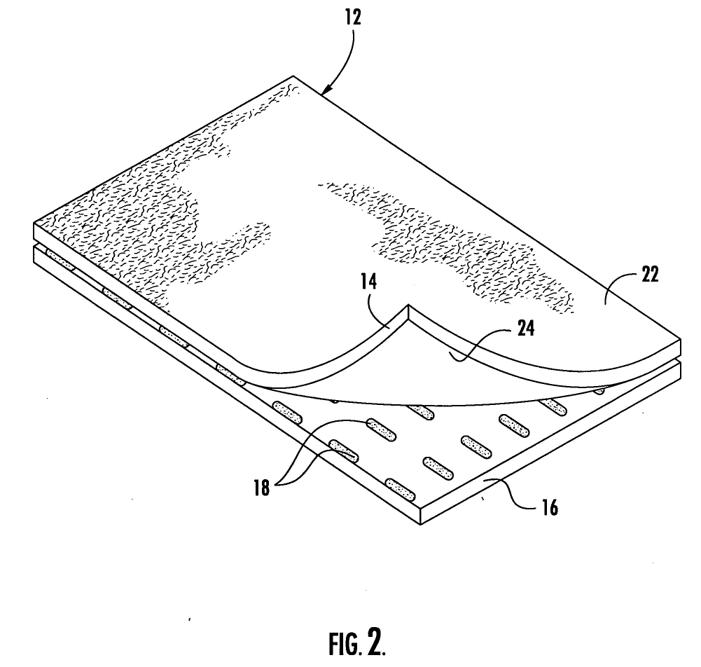

FIG. 2 illustrates in greater detail a composite fabric 12 in accordance with one embodiment of the present invention. As shown, the composite fabric 12 includes a first microporous ply 14 and a second microporous ply 16 positioned adjacent to the first microporous ply 14 and in opposing surface-to-surface relationship. In the embodiment shown, the first and second plies 14, 16 are joined together by bond sites 18 that bond the first and second plies 14, 16, to one another. It is important that the bond sites do not block the micropores of the plies. Therefore, the bond sites are discrete and spaced apart from one another. The bond sites 18 can be produced by any of a number of available methods. For example, the bond sites can be produced by an adhesive which is preferably applied in the form of a discontinuous adhesive layer. The adhesive layer can be applied by any of several conventional techniques. For example, the adhesive can be printed onto a surface of one or both plies using conventional printing methods and can be applied in various patterns, such as dots as shown in FIG. 2, or lines, stripes, intersecting lines, etc. Alternatively, the discontinuous adhesive layer 18 can comprise a preformed adhesive web that can be brought into contact with the two plies and combined by suitable application of pressure and heat. In yet another approach, the adhesive layer can be formed in situ by spraying or extruding a suitable pressure sensitive adhesive or hot melt adhesive composition. For example, a fine web of discontinuous adhesive can be produced by melt blowing a hot melt adhesive composition using conventional melt blowing technology, as described for example in Butin et al. U.S. Pat. No. 3,849,241. Another approach, known as powder bonding, involves using a finely divided granular or powdered material, such as a thermoplastic polymeric adhesive, which can be activated by heat. In yet another approach, the bond sites 18 can be produced by thermal or ultrasonic bonding.

In the composite fabric of FIG. 2, at least one of the plies is microporous and includes a nonwoven fabric substrate with a microporous coating of a thermoplastic resin. This microporous ply is preferably formed from a microporous formable resin that has been extrusion coated onto a nonwoven fabric substrate and subsequently stretched to impart microporosity. The nonwoven fibrous substrate can be formed of staple fibers or of continuous filaments. The fibers or filaments of the nonwoven substrate can be natural fibers or can be formed of synthetic polymers such as polyethylene, polypropylene, polyester, nylon, or blends or copolymers thereof. The nonwoven substrate can also be formed of bicomponent fibers or filaments. The nonwoven substrate may be made stable to gamma radiation by appropriate selection of fiber composition. The extrusion coating and stretching can be carried out generally in accordance with the process described in Wu et al. U.S. Pat. No. 5,865,926 or the process described in Brady et al. U.S. Pat. No. 6,258,308. The present invention thus benefits from the economics of these processes. Although the stretching can be carried out by a number of commercially available techniques, such as tentering, a preferred method of stretching is the technique known as incremental stretching or “ring-rolling”, which involves passing the extrusion-coated nonwoven substrate through a pair or pairs of interdigitating rollers. The incremental stretching can be in a single direction (i.e. in the machine direction or in the cross-machine direction) or it can be done in both directions. Fabrics produced in accordance with this process are permeable to moisture vapor, but form a barrier to penetration by liquids such as water. Fabrics produced by this process can consistently pass the blood barrier test of ASTM F1670. However, tests of such fabrics under the more severe viral barrier test of ASTM F1671 were unreliable. It was found that some samples passed the ASTM F1671 test while others taken from the same areas failed to pass the test.

The present invention overcomes these inconsistencies by producing a lightweight fabric that has been extrusion coated with a microporous formable resin and rendered microporous by stretching generally in accordance with the techniques described above, and combining this fabric with one or more additional plies to form a composite fabric. Although neither ply may consistently pass the ASMT F1671 test when tested as an individual layer, the resulting composite consistently passes ASTM F1671. This is possible since the first ply in contact with the challenge fluid reduces the passage of the bacteriophage challenge by many orders of magnitude. Any passage of bacteriophage coming into contact with the second ply will be of such a weak concentration that the second ply easily blocks the passage. In addition to reduced concentration, any bacteriophage (or virus) that passes through the first ply will be outside of the host liquid and thus must be extremely hardy to pose any significant challenge to the second ply. Table 1 illustrates the application of the ASTM F1671 test to a single ply and to a combined two ply composite of the present invention.

TABLE 1
ASTM F1671

| | Challenge | PFU on opposite side |
|---|---|---|
| Single Ply | 1 × 10⁸ pfu per ml. | 100 |
| Two Ply | 1 × 10⁸ pfu per ml. | 0 |

In one preferred embodiment of the present invention, the composite fabric is formed of two lightweight microporous plies, each produced in accordance with the teachings of the Wu et al. '926 patent and including a microporous formable resin that has been extrusion coated onto a nonwoven fabric substrate and incrementally stretched. Each ply of the composite fabric of the present invention preferably has a basis weight of from 20 to 85 gsm (grams per square meter), and more preferably from 25 to 60 gsm. The nonwoven fabric substrate is preferably a spunbond polypropylene nonwoven fabric. The microporous formable resin composition includes a relatively high percentage of a pore-forming filler, as well as conventional additives, stabilizers and processing aids. Typically, the pore-forming filler is an inorganic filler, such as calcium carbonate having a particle-size on the order of about 0.5 to 8 microns. The pore-forming filler is typically present at a concentration of from about 30 to 75% by weight, typically about 40 to 60% by weight.

In each such ply, the nonwoven fabric substrate 22 predominantly forms one of the exposed surfaces of the ply, and the extrusion coating of microporous formable resin defines a microporous film surface 24 at the opposite surface of the ply. The resin penetrates into the interstices of the nonwoven fabric substrate to form a unitary, integral composite. The microporous formable resin can be any thermoplastic resin that is suitable for processing by melt extrusion, but is preferably an olefin-based polymer, such as polyethylene or polypropylene, or copolymers, terpolymers or blends of olefin-based polymers with other materials such as ethylene vinyl acetate, ethylene methyl acrylate, ethylene acrylic acid, polylactic acid polymers, or blends.

By utilizing two components of a lightweight coated fabric, the probability of two pinholes or inconsistencies lining up directly upon one another in the laminate is remote. Since lightweight nonwovens are typically used in each ply, the probability of a pinhole due to a strand of nonwoven fiber extending through the coating is much less likely than it would be if a single heavier nonwoven substrate were used as a bilaminate stand-alone fabric. While one might expect that thicker layers of a similar barrier coating or film might also satisfy the viral barrier requirements, increases in coating or film thickness increase cost and decrease overall comfort by resulting in a stiffer, less drapeable, and noisier material. Multiple layers of thinner materials have been found more acceptable when considering these characteristics as compared to a single composite having the equivalent barrier layer thickness. Additionally, it can be seen from Table 2 below that the characteristic MVTR of two plies of the coated fabric components is not significantly lower than the individual components. This is especially significant to maintain comfort.

TABLE 2

| | MVTR (g/m²/24 hr) |
|---|---|
| Single Ply | 780 |
| Two Ply | 630 |

Another advantage of laminating two coated webs together is that a pressure sensitive adhesive (PSA) could be utilized without the inherent undesirable tacky feel on the nonwoven side. This is because the tackiness inherent in PSA adhesive is blocked by the existing coating on each component of the laminate.

FIG. 3 shows the composite of FIG. 2 on an enlarged scale. In this embodiment, the first and second plies 14, 16 are oriented with the film surfaces 24 facing outwardly, and the bond sites 18 thus bond the nonwoven surfaces 22 of the plies to one another.

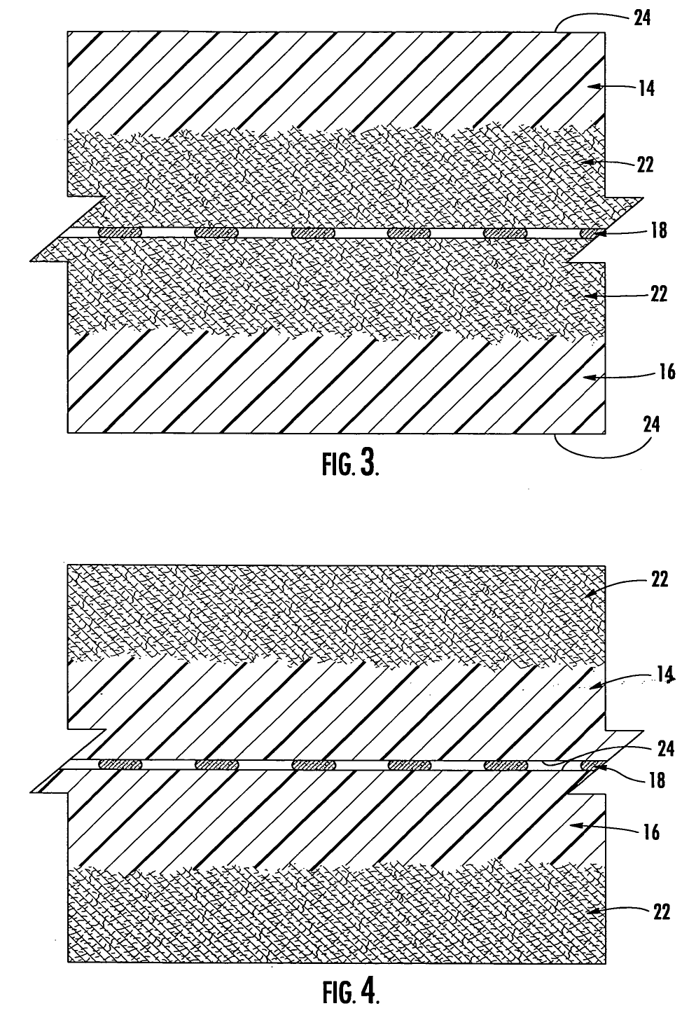

However, in an alternate embodiment, shown in FIG. 4, the film surfaces 24 can be oriented inwardly and bonded to one another. In this event, the nonwoven layers 22 are exposed at both surfaces of the composite fabric.

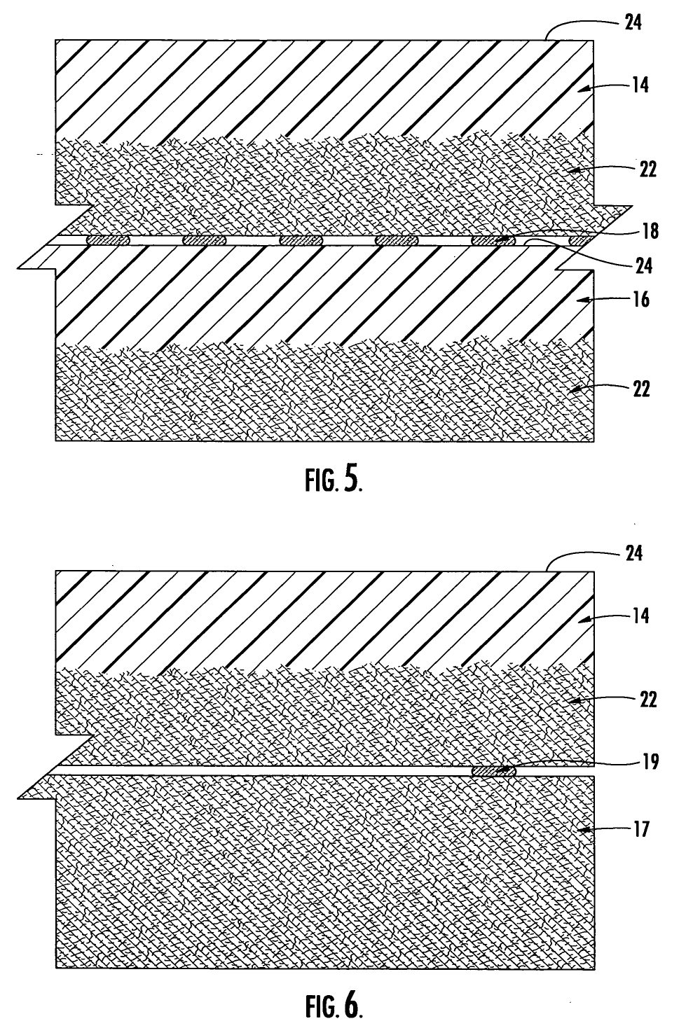

In yet another embodiment, shown in FIG. 5, the film surface 24 of one ply 16 is bonded to the nonwoven surface 22 of the adjacent ply 14. In this case, one exposed surface of the composite is formed by the film layer, and the opposite exposed surface is defined by the nonwoven layer.

In a further embodiment of the invention, the two plies can be joined to one another by thermal or ultrasonic spot bonding. This can be carried out generally in accordance with the teachings of Langley U.S. Pat. No. 5,409,761. The thermal or ultrasonic spot bonding can be carried out over the entire extent of the surface of the composite fabric. The plies can be oriented in either a film-to-film orientation, or a nonwoven-to-nonwoven orientation, or a film to nonwoven orientation.

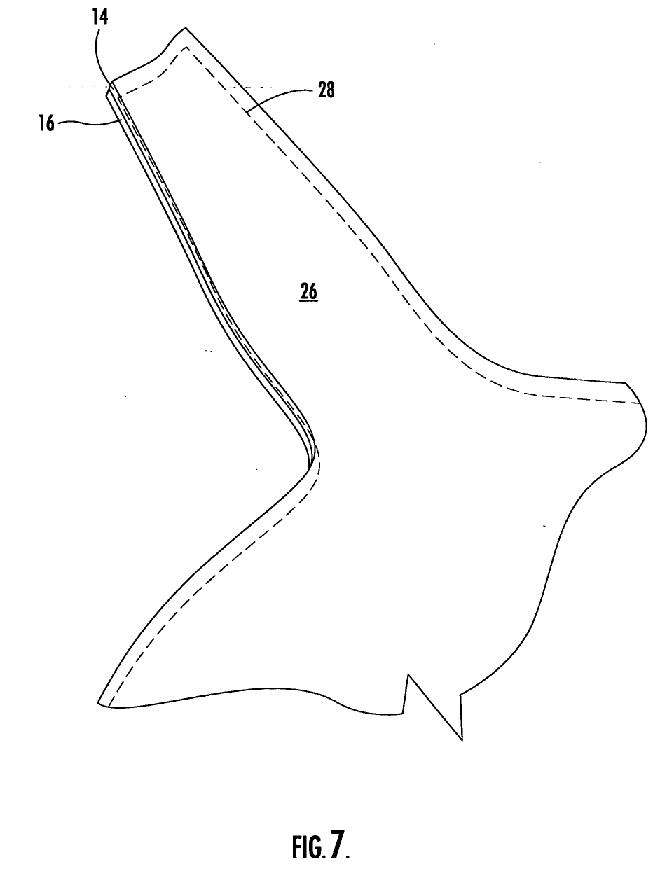

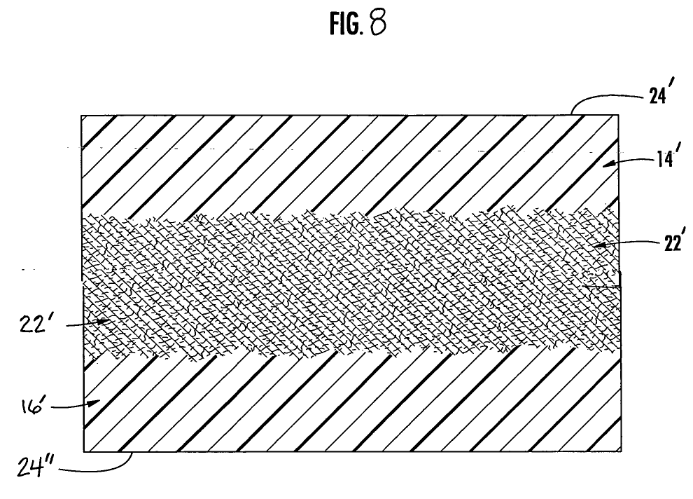

FIG. 6 illustrates an embodiment of the invention in which a first microporous ply 14, produced as described above and having a film surface 24 on one side and a nonwoven surface 22 on the opposite side, is positioned in opposing face-to-face relationship with a second ply 17 form of a nonwoven web. The nonwoven web can comprise a spunbonded web, a carded thermal bonded web, a spunlaced nonwoven web, or a nonwoven web of other known type. The two plies are separate from one another over substantially the entire extent of their opposing surfaces. They are connected to one another in certain selected areas, such as near the peripheral edge portions of the plies, to maintain the plies in close proximity to each other. The plies can be connected by a line of bonds, such as thermal or ultrasonic bonds, indicated at 19, or by stitching, to form a composite. This composite can be fabricated into medical protective apparel, such as medical gowns, shoe covers, head covers, face masks, sleeve protectors, or into surgical drapes.

According to another embodiment, a garment, such as a gown, is fabricated using two independent plies 14, 16 of extrusion coated microporous fabric. The plies need not be laminated, but can be joined together when the garment is fabricated and seamed. The two plies 14, 16 can be joined together only along peripheral edge portions of the two plies, with the two plies being otherwise unconnected. Thus for example, in fabricating a gown, two overlying plies can be cut into the shape of components that are to be assembled into a gown, such as a torso portion and a sleeve portion 26 as is shown in FIG. 6. The two plies 14, 16 can be joined only along the peripheral edges of the respective cutout shaped pieces. The joining together of the plies can be achieved by thermal or ultrasonic bonding, or by sewing, as indicated by the reference character 28.

In an alternative embodiment, the composite fabric of the invention could include one or more additional plies of a material different from that of the first microporous ply and which may or may not be microporous. Since the additional ply or plies will be exposed to a significantly lower challenge than the first ply, the additional ply could be produced according to a process other than that described in the Wu et al. '926 patent, and may be of a material which by itself would not pass ASTM F1670 or 1671. For example, the additional ply could be a microporous film alone, or a laminate of a microporous free film with a nonwoven layer. Alternatively, the additional ply or plies could be another nonwoven fabric, such as, for example, spunbond nonwovens, hydroentangled nonwoven, carded nonwovens, air-laid nonwovens, wet-laid nonwovens, meltblown nonwovens, or composites or laminates of such nonwovens.

Table 3 includes four basic embodiments and various iterations. Each example was fabricated according to the process of the Wu et al. '926 patent with changes being made to the thickness and color of the incrementally stretched calcium carbonate-filled microporous film, changes in the weight and color of the substrate, that being spunbonded polypropylene. However other substrates could be used, and changes in the percent engagement (i.e., stretching) which produced examples exhibiting varying air flow rates. It should be stated that MVTR was found to be independent of coating thickness, but the same conclusion could not be made relative to the percent engagement. What is evident from Table 3 is that it does not appear that a composite can be produced according to the Wu et al. '926 process that consistently passes the blood penetration test per ASTM F1670. ASTM F1670 is a method in common practice within the medical industry for evaluating the visual penetration of synthetic blood through a protective material. Materials that pass this test are considered blood barriers but can still allow the passage of viruses which is evaluated according to the more stringent viral resistance test as defined by ASTM F1671. Since these tests define a hierarchy of performance, materials failing F1670, will inherently fail F1671. The novelty of the present invention is that a multiple layer approach can be employed to pass the F1671 test with layers that otherwise fail this, and in certain combinations, even the lesser F1670 test.

The F1670 results presented in Table 3 were generated using an automated multi-celled F1670 device fabricated in-house within Kappler Inc. (Guntersville, Ala.). This device is designed to allow simultaneous testing of 15 samples per the ASTM F1670 method. The modification for this application is that the 54 minute post pressure exposure time as detailed in ASTM F1670 was not used in an attempt to generate a greater number of tests results. Experience within the industry has demonstrated that fabrics will fail this test during the initial 5 minute 0 pressure hold time, or during the subsequent 1 minute of pressurization at 2 psig, but not during the final 54 minutes which is again at 0 pressure. Example 1, and the associated iterations, which represent a 25 gsm coating weight of an incrementally stretched calcium carbonated filled polyolefin film on a 0.5 oz/yd² (16.9 gsm) spunbonded polypropylene, show blood penetration failures ranging from a low of 0.8% (i.e., 1 failure in 120 cells tested), to a high of 4.4% (i.e., 16 failures of 360 cells tested). Example 2, and the associated iterations, which represent a 30 gsm coating weight of an incrementally stretched calcium carbonated filled polyolefin film on a 1.0 osy spunbonded polypropylene, show blood penetration failures ranging from a low of 1.7% (i.e., 4 failures in 240 cells tested), to a high of 2.5%, that is 6 failures of 240 cells tested). Example 3, and the associated iterations, which represent a 45 gsm coating weight of an incrementally stretched calcium carbonated filled polyolefin film on a 1.0 osy spunbonded polypropylene, show blood penetration failures ranging from a low of 0% (i.e., 0 failures in 240 cells tested), to a high of 32%, that is 24 failures of 75 cells tested). When comparing the average blood penetration failures per cells tested, no significant difference was noticed between Examples 1 (i.e., average 2.8% failures), Example 2 (i.e., average 2.0% failures), and Example 3 (i.e., average 3.1%), even though the weight of the barrier layer was increased by 80%. Even if Example 3 was found to consistently pass the blood penetration test, at this weight, the fabric would be considered objectionably stiff and noisy which would limit its usefulness in the medical suite.

Table 4 summarizes results of the more stringent ASTM F1671 viral penetration test. This biological assay test is similar to F1670, however, with the addition of a viral surrogate phiX-174 bacteriophage to the synthetic blood test challenge. The same exposure parameters of 5 minutes at 0 pressure, 1 minute at 2 psig, and 54 minutes at 0 pressure are used. Examples of each embodiment are show in Table 4. Examples 1 and 2 show failures under F1670 and as expected, as well as subsequent failures under F1671. Example 3, which is the heavyweight microporous coating, shows a pass under F1670, and variable results under F1671. Example 4 represents 2 plies of example 1 and passes the F1670 test as well as the F1671 test. Unexpectedly, Example 5 represents a single layer of Example 1 tested in combination with a single layer of Sontara® Medical Grade (DuPont). Sontara® is a hydroentangled nonwoven that has been treated with a liquid repellency. The material exhibits high air permeability and as such, is very comfortable, but by itself offers very little resistance to blood and will fail the F1670 test almost immediately. However, when used in combination with a layer of incrementally stretched calcium carbonated filled polyolefin film, a very comfortable, quiet, blood and viral resistant composite is created. This unexpected result would appear to significantly broaden the types of materials that could be used in a 2-ply configuration to pass the requirements of ASTM F1671.

TABLE 3
BLOOD PENETRATION RESISTANCE

| | | | | MVTR | Blood |
|---|---|---|---|---|---|
| | | | | (% | Penetration |
| Example | Weight | Color | | open | failures/#cells |
| No. | coating/substrate | film/substrate | Airflow | cup) | tested) |
| 1 | 25 gsm/0.5 osy | white/white | 86 | 42 | 2/120 |
| | | white/white | 126 | 50 | 7/360 |
| | | white/blue | 82 | 41 | 3/120 |
| | | white/blue | 121 | 49 | 9/360 |
| | | blue/blue | 63 | 34 | 1/120 |
| | | blue/blue | 123 | 52 | 8/360 |
| | | blue/white | 71 | 41 | 5/120 |
| | | blue/white | 118 | 41 | 16/360 |
| | | blue/white | 127 | 47 | 10/240 |
| 2 | 30 gsm/1.0 osy | blue/white | 123 | 54 | 4/240 |
| | | blue/white | 140 | 63 | 4/240 |
| | | blue/blue | 128 | 58 | 5/240 |
| | | yellow/yellow | 115 | 41 | 6/240 |
| 3 | 45 gsm/1.0 osy | blue/white | 117 | 57 | 0/240 |
| | | white/white | 78 | 40 | 0/120 |
| | | white/white | 134 | 55 | 0/120 |
| | | white/white | 126 | 50 | 0/120 |
| | | white/blue | 70 | 35 | 1/120 |
| | | white/blue | 134 | 53 | 5/360 |
| | | white/blue | 133 | 62 | 2/1-5 |
| | | blue/blue | 122 | 51 | 7/360 |
| | | blue/blue | 140 | 65 | 9/120 |
| | | blue/blue | 156 | 70 | 7/120 |
| | | blue/blue | 191 | 70 | 12/120 |
| | | blue/blue | 193 | 78 | 24/75 |
| | | blue/blue | 125 | 55 | 1/240 |
| 4 | 25 gsm/0.5 osy | blue/white//blue/white | n/t | 41 | 0/120 |
| | (2-ply using | | | | |
| | same fabric) | | | | |
| 5 | 25 gsm/0.5 osy | blue/white//Sontara | n/t | n/t | n/t |
| | (2-ply using | | | | |
| | Sontara ® | | | | |
| | Medical Grade) | | | | |

TABLE 4
VIRAL RESISTANCE

| Example | Coating | Substrate | | | F1670 | |
|---|---|---|---|---|---|---|
| No. | Weight | Weight | # of Plies | MVTR | (mod.) | F1671 |
| 1 | 25 gsm | 0.5 osy | 1 | 47% | 10/240 | n/t |
| 2 | 30 gsm | 1.0 osy | 1 | 54% | 4/240 | Fail |
| 3 | 45 gsm | 1.0 osy | 1 | 57% | 0/240 | 6 Pass |
| | | | | | | 1 Fail |
| 4 | 25 gsm | .5 osy | 2(w/ | 41% | 0/120 | 6 Pass |
| | | | same) | | | |
| 5 | 25 gsm | .5 osy | 2 | n/t | n/t | Pass |
| | | | (w/Sontara | | | |
| | | | Medical | | | |
| | | | Grade) | | | |

A variation of the two ply structure to overcome the disadvantages of a thick coating is to apply a thin coating on opposite sides of a common nonwoven fabric substrate. The two relatively thin coatings would provide the barrier characteristics of a two layer fabric, allow the fabric to remain soft and drapable, and the weight of the common nonwoven could be chosen to provide whatever physical strength characteristics that are desired. It is desirable that the nonwoven also provide an air layer between the two thin coatings.

In the embodiment shown in FIG. 8, the composite includes a nonwoven fabric substrate 22′, a first microporous resin layer 14′ on-one surface-of the nonwoven-fabric substrate 22′ and a second microporous resin layer 16′ on the opposite surface of the nonwoven fabric substrate 22′. The microporous resin layers may be of the same or of different compositions. In one advantageous embodiment both the microporous resin layers 14′, 16′ are made from a thermoplastic microporous-formable resin containing a pore-forming filler as described earlier. The composite fabric has a microporous film surface 24′ on one side of the composite and a second microporous film surface 24″ on the opposite side.

Such a composite can be made by first extruding a microporous formable thermoplastic resin coating onto one surface of a nonwoven fabric substrate without stretching either the coating or nonwoven substrate. The coated nonwoven is then coated on the opposing surface either by inline tandem extrusion or by a subsequent coating of another microporous formable resin. The resultant composite is thereafter stretched to impart microporosity. The stretching can be accomplished by incremental stretching (ring rolling), machine direction only stretching, or by traditional tentering. Alternatively, the coated nonwoven fabric substrate can be stretched after the first coating operation to render the first coating microporous, and then the second coating is applied by extrusion coating, followed by a second stretching step.

In yet another embodiment, a microporous free (unsupported) film is laminated to the uncoated surface of the composite after the first coating and stretching operation. Alternatively, two microporous free films may be laminated to the opposite surfaces of the nonwoven substrate. Microporous free films of this type are commercially available from various sources and can be produced by various procedures such as those described, for example, in U.S. Pat. Nos. 4,350,655; 4,777,073; 5,594,070; and 5,690,949.

Examples of suitable nonwoven substrates include spunbond nonwoven webs, carded thermal bonded nonwoven webs, spunlaced nonwoven webs, wetlaid nonwoven webs, or combinations of two or more different kinds of nonwoven webs, such as a spunbond-meltblown composite or a spunbond-meltblown-spunbond composite. Suitable fiber compositions for the nonwoven fabric substrate include polyolefin fibers such as polypropylene, polyester fibers, nylon fibers, cellulosic fibers, acrylicfibers orblends thereof. The nonwoven fabric substrate may also comprises bicomponent fibers.

For protective garment applications, the nonwoven fabric substrate may suitably have a basis weight of from 0.5 to 3 ounces per square yard. The nonwoven fabric substrate and the resins used in the microporous layer may suitably be made from polymers which are stable to gamma irradiation.

Numerous modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A composite fabric comprising: a nonwoven fabric substrate having first and second opposite surfaces; a first microporous resin layer on said first surface of said nonwoven fabric substrate; and a second microporous resin layer on said second surface of said nonwoven fabric; wherein said first and second microporous resin layers fail the ASTM F1671 viral barrier test when tested as individual layers, but wherein the composite fabric passes the ASTM F1671 viral barrier test.

2. The fabric of claim 1, wherein at least one of the microporous resin layers comprises a microporous formable resin that has been extrusion coated onto the surface of said nonwoven fabric substrate and subsequently rendered microporous by stretching.

3. The fabric of claim 2, wherein both of said microporous resin layers comprise a microporous formable resin that has been extrusion coated onto the surface of said nonwoven fabric substrate and subsequently rendered microporous by stretching.

4. The fabric of claim 1, wherein at least one of the microporous resin layers comprises a microporous free film that has been laminated to the nonwoven fabric substrate.

5. The fabric of claim 4, wherein the other one of the microporous resin layers comprises a microporous formable resin that has been extrusion coated onto the surface of said nonwoven fabric substrate and subsequently rendered microporous by stretching.

6. A composite fabric comprising:
a nonwoven fabric substrate having first and second opposite surfaces;
a first microporous coating comprising a microporous formable resin that has been extrusion coated onto said first surface of said nonwoven fabric substrate and subsequently stretched to impart microporosity, and
a second microporous coating comprising a microporous formable resin that has been extrusion coated onto said second surface of said nonwoven fabric substrate and subsequently stretched to impart microporosity.

7. The fabric of claim 6, wherein said first and second coatings fail the ASTM F1671 viral barrier test when tested as individual layers, but wherein the composite fabric passes the ASTM F1671 viral barrier test.

8. The fabric of claim 6 wherein the MVTR of the composite fabric is at least 300 g/m²/24 hr.

9. The fabric of claim 8 where the MVTR is at least 600 g/m²/24 hr.

10. The fabric of claim 6 additionally including at least one additional ply, and discrete bond sites connecting said nonwoven fabric to said at least one additional ply to form a composite fabric.

11. The fabric of claim 10, including a discontinuous adhesive forming said bond sites connecting said nonwoven fabric to said at least one additional ply.

12. The fabric of claim 10, including thermal or ultrasonic bonds forming said bond sites connecting said nonwoven fabric to said at least one additional ply.

13. The fabric of claim 10, wherein said at least one additional ply comprises a second microporous ply comprising a nonwoven fabric substrate and a microporous formable resin that has been extrusion coated onto said nonwoven fabric substrate and subsequently stretched to impart microporosity.

14. The fabric of claim 10, wherein said at least one additional ply comprises an unsupported microporous film.

15. The fabric of claim 10, wherein said at least one additional ply comprises a nonwoven fabric.

16. The fabric of claim 6, wherein said nonwoven fabric substrate is selected from the group consisting of spunbond nonwovens, hydroentangled nonwovens, carded nonwovens, air-laid nonwovens, wet-laid nonwovens, meltblown nonwovens, or composites or laminates of such nonwovens.

17. The fabric of claim 6, which has been stretched and rendered microporous by a procedure selected from the group consisting of incremental stretching, tentering and machine direction only stretching.

18. The fabric of claim 6, wherein the nonwoven fabric substrate has a basis weight of from 0.5 to 3 ounces per square yard.

19. The fabric of claim 6, wherein said first and second coatings comprise a polyolefin resin containing a calcium carbonate filler.

20. The fabric of claim 6, wherein the nonwoven fabric substrate and the microporous formable resins of said first and second coatings are made from polymers which are stable to gamma irradiation.

21. Medical protective apparel fabricated from the fabric of claim 1.

22. Medical protective apparel of claim 21 in the form of medical gowns, foot covers, head covers, face masks, or sleeve protectors.

23. A surgical drape fabricated from the composite fabric claim 1.

24. A method of making a composite fabric comprising: providing a nonwoven fabric substrate having first and second opposite surfaces; applying a first a microporous resin layer to the first surface of said nonwoven fabric substrate; applying a second microporous resin layer to the second surface of said nonwoven fabric substrate; and wherein said first and second microporous layers fail the ASTM F1671 viral barrier test when tested as individual layers, but wherein the composite fabric passes the ASTM F1671 viral barrier test.

25. The method of claim 24, wherein the step of applying a first microporous layer comprises extrusion coating a microporous formable resin onto the surface of said nonwoven fabric substrate and subsequently stretching to render the composite microporous.

26. The method of claim 25, wherein the step of applying a second microporous layer comprises extrusion coating a microporous formable resin onto the surface of said nonwoven fabric substrate and subsequently stretching to render the composite microporous.

27. The method of claim 26, wherein the stretching step is performed after extrusion coating both the first and second layers.

28. The method of claim 26, which includes a first stretching step performed after extrusion coating of the first layer and a second stretching step performed after extrusion coating of the second layer.

29. The method of claim 24, wherein the step of applying a first microporous layer comprises laminating a microporous film layer to the surface of said nonwoven fabric substrate.

30. A method of making a composite nonwoven fabric comprising:
providing a nonwoven fabric substrate having first and second opposite surfaces;
forming a first coating of a microporous formable resin on the first surface of said nonwoven fabric substrate;
forming a second coating of a microporous formable resin on the second surface of said nonwoven fabric substrate; and
stretching the coated nonwoven fabric substrate to impart microporosity to said first and second coatings.

31. The method of claim 30, wherein said stretching step comprises incrementally stretching the substrate between cooperating interdigitating grooved rolls.

32. The method of claim 30, wherein said stretching step comprises incrementally stretching the substrate in the machine direction only.

33. The method of claim 30, wherein said stretching step comprises incrementally stretching the substrate on a tenter frame.

34. The method of claim 30 wherein the stretching step is performed when the composite is at ambient temperature.

35. The method of claim 30 wherein the stretching step is performed when the composite is heated to an elevated temperature.

36. The method of claim 35, wherein the stretching step is performed when the composite is heated to a temperature above the glass transition temperature of the resin.

37. The method of claim 30, wherein said first and second coatings fail the ASTM F1671 viral barrier test when tested as individual layers, but wherein the composite fabric passes the ASTM F1671 viral barrier test.
